(19) United States
(12) Patent Application Publication
(10) Pub. No.: US 2015/0229206 A1
(43) Pub. Date: Aug. 13, 2015

(54) ELECTRICAL POWER CONVERTER

(71) Applicant: TOYOTA JIDOSHA KABUSHIKI KAISHA, Toyota-shi (JP)

(72) Inventors: Masaya KAJI, Toyota-shi (JP); Hitoshi IMURA, Chiryu-shi (JP); Hiromi YAMASAKI, Toyota-shi (JP); Masanori ISHIGAKI, Nagakute-shi (JP); Naoki YANAGIZAWA, Nagakute-shi (JP); Shuji TOMURA, Nagakute-shi (JP)

(21) Appl. No.: 14/618,272

(22) Filed: Feb. 10, 2015

(30) Foreign Application Priority Data
Feb. 12, 2014 (JP) 2014-024350

(51) Int. Cl. H02M 3/04

(52) U.S. Cl. CPC H02M 3/04

(57) ABSTRACT

An electrical power converter is configured to perform an electrical power conversion with two electricity storage apparatuses, the electrical power converter has: four switching elements which are electrically connected in series and which are housed in the electrical power converter such that the four switching elements are located at four corners of a planar quadrangular region respectively; a first conductive path which electrically connects a first and second switching elements among the four switching elements; and a second conductive path which electrically connects a third and fourth switching elements among the four switching elements, wherein the second conductive path intersects with the first conductive path in a planar view.

### TECHNICAL FIELD

The present invention relates to an electrical power converter which is configured to perform an electrical power conversion with an electricity storage apparatus, for example.

### BACKGROUND ART

An electrical power converter, which is configured to perform an electrical power conversion with an electricity storage apparatus such as a secondary battery, a capacitor and the like by changing a switching state of each of switching elements, is known. With respect to the electrical power converter like this, a Patent Literature 1 proposes a technology for suppressing a surge voltage and a snubber voltage by decreasing an inductance of an electrical path which connects the switching elements. Specifically, the Patent Literature 1 proposes a technology for suppressing the surge voltage and the snubber voltage by electrically connecting connection terminals of a plurality of semiconductor modules, in each of which the switching element and a diode are housed (included), at an intermediate position.

Patent Literatures 2 and 3 are listed as background art documents which disclose a background art relating to the present invention, as well as the Patent Literature 1. The Patent Literatures 2 and 3 disclose a technology for decreasing an inductance of a semiconductor device by applying electrical currents, whose flowing direction are opposite to each other, to parasitic inductances of the plurality of wirings which are close to each other.

### CITATION LIST

### Patent Literature

Patent Literature 1: Japanese Patent Application Laid Open No. 2011-244640

Patent Literature 2: Japanese Patent Application Laid Open No. 2013-219290

Patent Literature 3: Japanese Patent Application Laid Open No. 2013-141035

### SUMMARY OF INVENTION

### Technical Problem

An electrical power converter which is configured to simultaneously perform the electrical power conversion with a plurality of electricity storage apparatuses is proposed, recently. The electrical power converter like this has three or more switching elements which are electrically connected in series as the switching elements for simultaneously converting the electrical power with the plurality of electricity storage apparatuses. For example, if the electrical power converter is equipped on a vehicle which moves (drives) by using the electrical power outputted from two electricity storage apparatuses, the electrical power converter has four switching elements which are electrically connected in series as the switching elements for simultaneously converting the electrical power with two electricity storage apparatuses.

When the switching elements are electrically connected in series, the parasitic inductance of an electrical current circuit is simply added due to the series connection of the switching elements. Therefore, the larger the number of the switching elements which are electrically connected in series is, the more the parasitic inductance of an electrical current circuit which passes through the switching elements increases. The increase of the inductance (typically, the parasitic inductance) sometimes lead to an increase of the surge voltage and the snubber voltage. Therefore, a reduction (a decrease) of the inductance is desired more in the electrical power converter having the plurality of switching elements which are electrically connected in series.

However, the Patent Literature 1 merely discloses a method of connecting (arranging) the switching elements (S1), which are for simultaneously converting the electrical power with the electricity storage apparatus, in parallel. Namely, the Patent Literature 1 does not disclose a method of connecting (arranging) the switching elements in the case where the number of the series-connected switching elements becomes large (for example, becomes four).

The subject to be solved by one aspect of the present invention discussed herein includes the above as one example. It is therefore an object of the present invention to provide an electrical power converter which is capable of reducing (decreasing) the inductance even in the case where the electrical power converter has four switching elements which are electrically connected in series.

### Solution to Problem

An electrical power converter of the present invention is configured to perform an electrical power conversion with two electricity storage apparatuses, the electrical power converter has: four switching elements which are electrically connected in series and which are housed in the electrical power converter such that the four switching elements are located at four corners of a planar quadrangular region respectively; a first conductive path which electrically connects a first and second switching elements among the four switching elements; and a second conductive path which electrically connects a third and fourth switching elements among the four switching elements, wherein the second conductive path intersects with the first conductive path in a planar view.

The electrical power converter of the present invention is capable of performing the electrical power conversion with the two electricity storage apparatuses. The electrical power converter has at least the four switching elements (namely, the first switching element, the second switching element, the third switching element and the fourth switching element), the first conductive path and the second conductive path, in order to perform the electrical power conversion with the two electricity storage apparatuses.

The four switching elements are electrically connected in series. Each of the four switching elements is capable of switching (in other words, changing a switching state thereof) under a control of a controller. The timely switching of each of the four switching elements (in other words, the timely change of the switching state of each of the four switching elements) allows the electrical power converter to perform the electrical power conversion with two electricity storage apparatuses.

Especially in the present invention, the four switching elements are housed (included, placed) in the electrical power converter such that the four switching elements are located at the four corners (in other words, four vertexes) of the planar quadrangular region, respectively. In other words, the four switching elements are housed in the electrical power converter such that a virtual line which connects the four switching elements forms the planer quadrangular region. In other words, the four switching elements are housed in the electrical power converter to be arranged in a square arrangement manner (alternatively, a matrix arrangement manner).

The first conductive path electrically connects two switching elements (specifically, the first and second switching elements) among the four switching elements. On the other hand, the second conductive path electrically connects the other two switching elements (specifically, the third and fourth switching elements which are different from the first and second switching elements) among the four switching elements.

Especially in the present invention, the first conductive path and the second conductive path intersect with each other. In other words, the four switching elements are housed in the electrical power converter such that the first conductive path and the second conductive path are arranged to intersect with each other.

For example, each of the first and second conductive paths may electrically connect two switching elements which are located on a diagonal line of the planar quadrangular region among the four switching elements which are located at the four corner of the planar quadrangular region respectively, because the first and second conductive paths intersect with each other. Namely, the first conductive path may electrically connect two switching elements (specifically, the first and second switching elements) which are located on a first diagonal line of the planar quadrangular region among the four switching elements. On the other hand, the second conductive path may electrically connect the other two switching elements (specifically, the third and fourth switching elements) which are located on a second diagonal line of the planar quadrangular region among the four switching elements. As a result, the first and second conductive paths intersect with each other.

Incidentally, it is preferable that the first and second conductive paths be insulated at a position where the first and second conductive paths intersect with each other. Namely, it is preferable that some kind of countermeasure, which prevents the first and second conductive paths from electrically shorting, be implemented with respect to the first and second conductive paths.

As described above, in the present invention, the first and second conductive paths intersect with each other. Thus, as described later in detail by using drawings, a flowing direction of an electrical current which flows through at least one portion of the first conductive path is likely opposite to a flowing direction of an electrical current which flows through at least one portion of the second conductive path. When the electrical currents, whose flowing direction are opposite to each other, flow through the first and second conductive paths, respectively, an inductance (for example, a parasitic inductance) of the first conductive path and an inductance (for example, a parasitic inductance) of the second conductive path cancel (compensate) each other. Therefore, the inductance of the electrical power converter is appropriately reduced (decreased) even in the case where the four switching elements are electrically connected in series.

In addition, in the present invention, the four switching elements are located on the four corners of the planar quadrangular region, respectively. Therefore, the electrical power converter decreases in size compared to an electrical power converter in which four switching elements are arranged to line along a straight line (in other words, physically in tandem). The reason is as follows. A region where the four switching elements are located is more likely to excessively extend along one direction (specifically, a direction along which the four switching elements line), if the four switching elements line along the straight line. On the other hand, the region where the four switching elements are located is less likely to excessively extend along the one direction, if the four switching elements are located on the four corners of the planar quadrangular region. As a result, another circuit element (for example, a reactor, a capacitor and the like) which composes the electrical power converter can be located beside the four switching elements which are located on the four corners of the planar quadrangular region. Thus, the electrical power converter decreases in size compared to an electrical power converter in which another circuit element is located beside the four switching elements which line on the straight line.

In another aspect of the electrical power converter of the present invention, at least one portion of the first conductive path extends along a direction along which at least one portion of the second conductive path extends.

According to this aspect, the flowing direction of the electrical current which flows through at least one portion of the first conductive path is likely opposite to the flowing direction of the electrical current which flows through at least one portion of the second conductive path. Therefore, the inductance of the electrical power converter is appropriately reduced (decreased) even in the case where the four switching elements are electrically connected in series.

In another aspect of the electrical power converter of the present invention, a flowing direction of an electrical current which flows through at least one portion of the first conductive path is opposite to a flowing direction of an electrical current which flows through at least one portion of the second conductive path.

According to this aspect, the flowing direction of the electrical current which flows through at least one portion of the first conductive path is opposite to the flowing direction of the electrical current which flows through at least one portion of the second conductive path. Thus, the inductance of the first conductive path and the inductance of the second conductive path cancel (compensate) each other. Therefore, the inductance of the electrical power converter is appropriately reduced (decreased) even in the case where the four switching elements are electrically connected in series.

In another aspect of the electrical power converter of the present invention, the electrical power converter further has: a smoothing capacitor which is electrically connected in parallel to the four switching elements; a third conductive path which electrically connects the smoothing capacitor and the first switching element; and a fourth conductive path which electrically connects the fourth switching element and the smoothing capacitor, at least one portion of the fourth conductive path extends along a direction along which at least one portion of the third conductive path extends in a planar view.

According to this aspect, the electrical power converter has the smoothing capacitor, the third conductive path and the fourth conductive path.

The smoothing capacitor is electrically connected in parallel to the four switching elements. The smoothing capacitor mainly suppresses a fluctuation (what we call a ripple) of an electrical current or an electrical voltage on a wiring to which the smoothing capacitor is electrically connected (typically, on a wiring to which the electrical power converted by the switching of the four switching elements is supplied).

The third conductive path electrically connects the smoothing capacitor and the first switching element. Specifically, the third conductive path electrically connects one terminal of the smoothing capacitor and one terminal (specifically, one terminal which is different from another terminal which is electrically connected to the second switching element by the first conductive path) of the first switching element.

The fourth conductive path electrically connects the fourth switching element and the smoothing capacitor. Specifically, the fourth conductive path electrically connects another terminal (specifically, another terminal which is different from the one terminal which is electrically connected to the first switching element by the third conductive path) of the smoothing capacitor and one terminal (specifically, one terminal which is different from another terminal which is electrically connected to the third switching element by the second conductive path) of the fourth switching element.

Especially in this aspect, at least one portion of the fourth conductive path extends along the direction along which at least one portion of the third conductive path extends. Namely, at least one portion of the third conductive path and at least one portion of the fourth conductive path extend along the same direction. Thus, as described later in detail by using drawings, a flowing direction of an electrical current which flows through at least one portion of the third conductive path is likely opposite to a flowing direction of an electrical current which flows through at least one portion of the fourth conductive path. When the electrical currents, whose flowing direction are opposite to each other, flow through the third and fourth conductive paths, respectively, an inductance (for example, a parasitic inductance) of the third conductive path and an inductance (for example, a parasitic inductance) of the fourth conductive path cancel (compensate) each other. Therefore, the inductance of the electrical power converter is appropriately reduced (decreased) even in the case where the four switching elements are electrically connected in series.

In another aspect of the electrical power converter having the third and fourth conductive paths as described above, the electrical power converter further has a fifth conductive path which electrically connects the second and third switching elements, at least one portion of the fifth conductive path extends along a direction along which at least one of at least one portion of the third conductive path and at least one portion of the fourth conductive path extends in a planar view.

According to this aspect, the electrical power converter has the fifth conductive path. The fifth conductive path electrically connects the second switching element and the third switching element. Specifically, the fifth conductive path electrically connects one terminal (specifically, one terminal which is different from another terminal which is electrically connected to the first switching element by the first conductive path) of the second switching element and one terminal (specifically, one terminal which is different from another terminal which is electrically connected to the fourth switching element by the second conductive path) of the third switching element.

Especially in this aspect, at least one portion of the fifth conductive path extends along the direction along which at least one of at least one portion of the third conductive path and at least one portion of the fourth conductive path extends. Namely, at least one portion of the fifth conductive path and at least one of at least one portion of the third conductive path and at least one portion of the fourth conductive path extend along the same direction. Thus, as described later in detail by using drawings, a flowing direction of an electrical current which flows through at least one portion of the fifth conductive path is likely opposite to a flowing direction of an electrical current which flows through at least one of at least one portion of the third conductive path and at least one portion of the fourth conductive path. When the electrical currents, whose flowing direction are opposite to each other, flow through the fifth conductive path and at least one of the third and fourth conductive paths, respectively, an inductance (for example, a parasitic inductance) of the fifth conductive path and an inductance (for example, a parasitic inductance) of at least one of the third and fourth conductive paths cancel (compensate) each other. Therefore, the inductance of the electrical power converter is appropriately reduced (decreased) even in the case where the four switching elements are electrically connected in series.

Incidentally, the electrical power converter may have another circuit element which is electrically connected in parallel to the four switching elements, in addition to or instead of the smoothing capacitor. In this case, the electrical power converter may have: a sixth conductive path which electrically connects another circuit element and the first switching element; and a seventh conductive path which electrically connects the fourth switching element and another circuit element, wherein at least one portion of the seventh conductive path may extend along a direction along which at least one portion of the sixth conductive path extends in a planar view. Furthermore, in this case, the electrical power converter further may have an eighth conductive path which electrically connects the second and third switching elements, wherein at least one portion of the eighth conductive path may extend along a direction along which at least one of at least one portion of the sixth conductive path and at least one portion of the seventh conductive path extends in a planar view.

In another aspect of the electrical power converter of the present invention, the four switching elements are housed in the electrical power converter such that the first and second switching elements are located on a diagonal line of the planar quadrangular region and the third and fourth switching elements are located on a diagonal line of the planar quadrangular region.

According to this aspect, the electrical power converter is capable of appropriately housing the four switching elements such that the four switching elements are located at the four corners of the planar quadrangular region and the first and second conductive paths intersect with each other.

In another aspect of the electrical power converter of the present invention, the electrical power converter further has a cooler to which a coolant for cooling the four switching elements is supplied, wherein one switching element whose heat generation amount is largest among the four switching elements is located at more upstream part along a supplying direction of the coolant than the other switching elements other than the one switching element among the four switching elements.

According to this aspect, the one switching element is located to be adjacent or close to an relative upstream part of the cooler along the supplying direction of the coolant, compared to the other switching elements. A cooling effect of an upstream part of the cooler along the supplying direction of the coolant is higher than a cooling effect of a downstream part of the cooler along the supplying direction of the coolant. Thus, the one switching element whose heat generation amount (for example, the heat generation amount caused by the electrical power conversion) is largest is appropriately cooled. Therefore, a performance deterioration caused by the heat generation of the one switching element whose heat generation amount is largest is appropriately suppressed.

These operation and other advantages in the present invention will become more apparent from the embodiments explained below. The object and advantages of the present invention will be realized and attained by means of the elements and combinations particularly pointed out in the claims. It is to be understood that both the foregoing general description and the following detailed description are exemplary and explanatory and are not restrictive of the embodiment, as claimed.

### BRIEF DESCRIPTION OF DRAWINGS

FIG. 1 is a block diagram illustrating a structure of a vehicle of a present embodiment.

FIG. 2 is a circuit diagram illustrating a circuit structure of an electrical power converter.

FIG. 3A is a side view illustrating an external appearance of the electrical power converter.

FIG. 3B is a top view illustrating an external appearance of the electrical power converter.

FIG. 4A is a top view illustrating a first example of an arrangement aspect of four semiconductor modules in which series-connected four switching elements are housed respectively.

FIG. 4B is a planar view illustrating conductive paths of a conductive module in the first example.

FIG. 5A is a top view illustrating a comparative example of an arrangement aspect in which four semiconductor modules, in which series-connected four switching elements are housed respectively, are arranged to line along a straight line.

FIG. 5B is a planar view illustrating conductive paths of a conductive module in the comparative example.

FIG. 6A is a top view illustrating a second example of an arrangement aspect of four semiconductor modules in which series-connected four switching elements are housed respectively.

FIG. 6B is a planar view illustrating conductive paths of a conductive module in the second example.

### DESCRIPTION OF EMBODIMENTS

Next, with reference to drawings, an embodiment of an electrical power converter will be explained. Incidentally, in the following explanation, an embodiment in which the electrical power converter of the present invention is applied to a vehicle (especially, a vehicle which moves (drives) by using an electrical power outputted from the electricity storage apparatus) will be explained. However, the electrical power converter may be applied to any equipment other than the vehicle.

(1) Structure of Vehicle

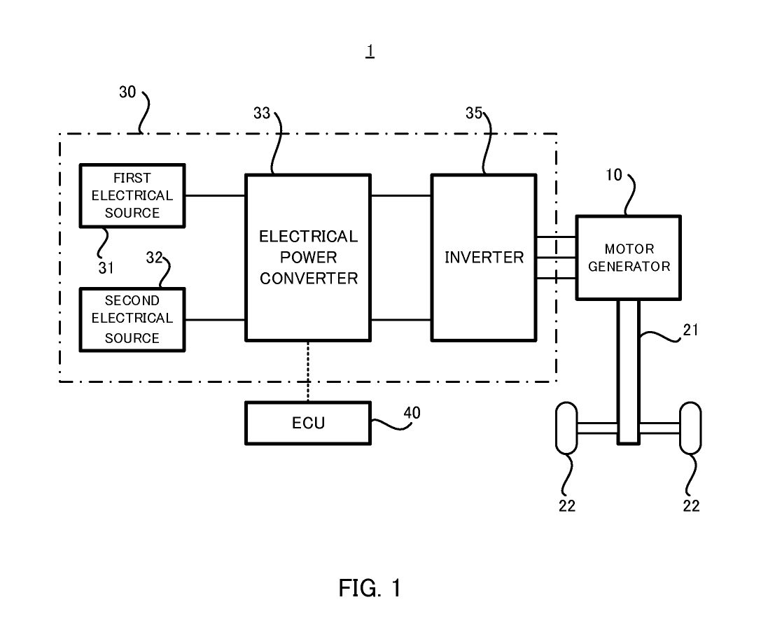

Firstly, with reference to FIG. 1, the structure of the vehicle 1 of the present embodiment will be explained. FIG. 1 is a block diagram illustrating the structure of the vehicle 1 of the present embodiment.

As illustrated in FIG. 1, the vehicle 1 has a motor generator 10, an axle shaft 21, wheels 22, an electrical source system 30 and an ECU 40.

The motor generator 10 operates by using an electrical power outputted from the electrical source system 30 when the vehicle 1 is in a power running state. Thus, the motor generator 10 mainly functions as a motor for supplying a power (namely, a power which is required for the vehicle 1 to move) to the axle shaft 21. Furthermore, the motor generator 10 mainly functions as a generator for charging a first electrical source 31 and a second electrical source 32 in the electrical source system 30 when the vehicle 1 is in a regeneration state.

The axle shaft 21 is a power transmission shaft which transmits the power outputted from the motor generator 10 to the wheels 22.

The wheels 22 transmit the power transmitted via the axle shaft 21 to a road. FIG. 1 illustrates an example in which the vehicle 1 has one wheel 22 at each of right and left sides. However, it is actually preferable that the vehicle 1 have one wheel 22 at each of a front-right side, a front-left side, a rear-right side and a rea-left side (namely, have four wheels 22 in total).

Incidentally, FIG. 1 illustrate the vehicle 1 having one motor generator 10. However, the vehicle 1 may have two or more motor generators 10. Furthermore, the vehicle 1 may have an engine in addition to the motor generator 10. Namely, the vehicle 1 of the present embodiment may be an EV (Electrical Vehicle) or a HV (Hybrid Vehicle).

The electrical source system 30 outputs the electrical power, which is required for the motor generator 10 to function as the motor, to the motor generator 10, when the vehicle 1 is in the power running state. Furthermore, the electrical power which is generated by the motor generator 10 functioning as the generator is inputted from the motor generator 10 to the electrical source system 30, when the vehicle 1 is in the regeneration state.

The electrical source system 30 has the first electrical source 31 which is one example of the “electricity storage apparatus”, the second electrical source 32 which is one example of the “electricity storage apparatus”, an electrical power converter 33 and an inverter 35.

Each of the first electrical source 31 and the second electrical source 32 is an electrical source which is capable of outputting the electrical power (namely, discharging). Each of the first electrical source 31 and the second electrical source 32 may be an electrical source to which the electrical power can be inputted (namely, which can be charged), in addition to be capable of outputting the electrical power. At least one of the first electrical source 31 and the second electrical source 32 may be a secondary battery which is capable of discharging and being charged by using an electrochemical reaction (namely, a reaction to convert a chemical energy to an electrical energy) and so on. The secondary battery may be a lead battery, a lithium-ion battery, a nickel-hydrogen battery, a fuel battery or the like, for example. Alternatively, at least one of the first electrical source 31 and the second electrical source 32 may be a capacitor which is capable of discharging and being charged by using a physical effect or a chemical effect to store an electrical charge. The capacitor may be an electrical double layer capacitor or the like, for example.

The electrical power converter 33 converts the electrical power which is outputted from the first electrical source 31 and the electrical power which is outputted from the second electrical source 32 depending on a required electrical power which is required for the electrical source system 30 (in this case, the required electrical power is an electrical power which the electrical source system 30 should output to the motor generator 10, for example), under the control of the ECU 40. The electrical power converter 33 outputs the converted electrical power to the inverter 35. Furthermore, the electrical power converter 33 converts the electrical power which is inputted from the inverter 35 (namely, the electrical power which is generated by the regeneration of the motor generator 10) depending on the required electrical power which is required for the electrical source system 30 (in this case, the required electrical power is an electrical power which should be inputted to the electrical source system 30, and the required electrical power is substantially an electrical power which should be inputted to the first electrical source 31 and the second electrical source 32, for example), under the control of the ECU 40. The electrical power converter 33 outputs the converted electrical power to at least one of the first electrical source 31 and the second electrical source 32. The above described electrical power conversion allows the electrical power converter 33 to distribute the electrical power among the first electrical source 31, the second electrical source 32 and the inverter 35.

The inverter 35 converts the electrical power (DC (direct current) electrical power), which is outputted from the electrical power converter 33, to an AC (alternating current) electrical power, when the vehicle 1 is in the power running state. Then, the inverter 35 supplies the electrical power, which is converted to the AC electrical power, to the motor generator 10. Furthermore, the inverter 35 converts the electrical power (AC electrical power), which is generated by the motor generator 10, to the DC electrical power. Then, the inverter 35 supplies the electrical power, which is converted to the DC electrical power, to the electrical power converter 33.

The ECU 40 is an electrical controlling unit which is configured to control the whole of the operation of the vehicle 1. The ECU 40 has a CPU (Central Processing Unit), a ROM (Read Only Memory), a RAM (Random Access Memory) and so on.

(2) Circuit Structure of Electrical Power Converter

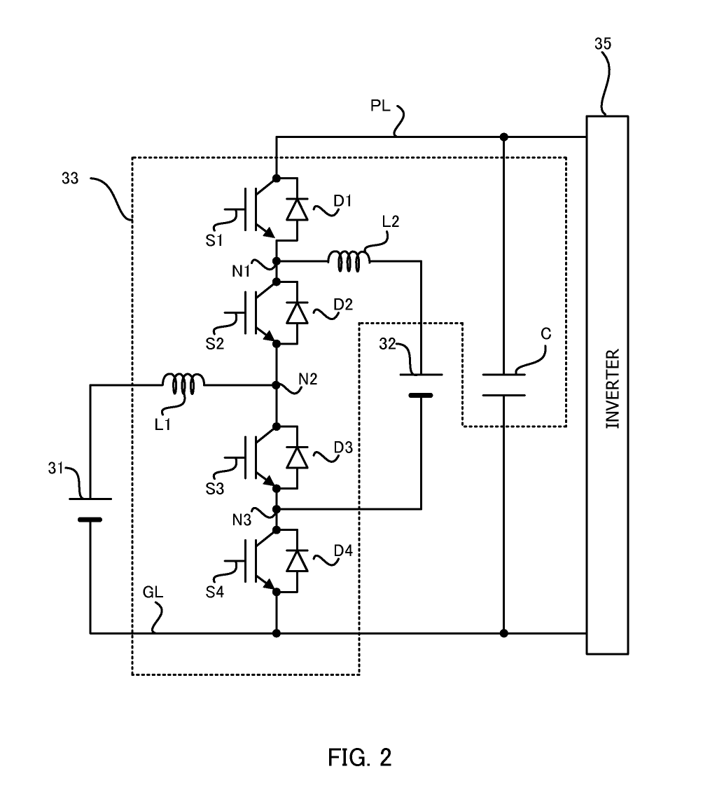

Next, with reference to FIG. 2, the circuit structure of the electrical power converter 33 will be explained. FIG. 2 is a circuit diagram illustrating the circuit structure of the electrical power converter 33.

As illustrated in FIG. 2, the electrical power converter 33 has a switching element S1, a switching element S2, a switching element S3, a switching element S4, a diode D1, a diode D2, a diode D3, a diode D4, a reactor L1, a reactor L2 and a smoothing capacitor C. Incidentally, the switching element S1 is one example of the “first switching element”. The switching element S2 is one example of the “second switching element”. The switching element S3 is one example of the “third switching element”. A switching element S4 is one example of the “fourth switching element”.

The switching element S1 is capable of changing a switching state thereof depending on a control signal which is supplied from the ECU 40. Namely, the switching element S1 is capable of changing the switching state thereof from an ON state to an OFF state or from the OFF state to the ON state. An IGBT (Insulated Gate Bipolar Transistor), a MOS (Metal Oxide Semiconductor) transistor for the electrical power or a bipolar transistor for the electrical power may be used as the switching element S1. The above explanation on the switching element S1 can be applied to the remaining switching elements S2 to S4.

The switching elements S1 to S4 are electrically connected in series between an electrical source line PL and a ground line GL. Specifically, the switching element S1 is electrically connected between the electrical source line PL and a node N1. The switching element S2 is electrically connected between the node N1 and a node N2. The switching element S3 is electrically connected between the node N2 and a node N3. The switching element S4 is electrically connected between the node N3 and the ground line GL.

The diode D1 is electrically connected in parallel to the switching element S1. The diode D2 is electrically connected in parallel to the switching element S2. The diode D3 is electrically connected in parallel to the switching element S3. The diode D4 is electrically connected in parallel to the switching element S4. Incidentally, the diode D1 is connected in an inverse-parallel manner to the switching element S1. Same argument can be applied to the remaining diodes D2 to D4.

The reactor L1 is electrically connected between a positive terminal of the first electrical source 31 and the node N2. The reactor L2 is electrically connected between a positive terminal of the second electrical source 32 and the node N1. The smoothing capacitor C is electrically connected between the electrical source line PL and the ground line GL. A negative terminal of the first electrical source 31 is electrically connected to the ground line GL. A negative terminal of the second electrical source 32 is electrically connected to the node N3. The inverter 35 is electrically connected between the electrical source line PL and the ground line GL.

The electrical power converter 33 has a chopper circuit for each of the first electrical source 31 and the second electrical source 32. As a result, the electrical power converter 33 is capable of performing the electrical power conversion with the first electrical source 31 and the second electrical source 32.

Specifically, a first chopper circuit in which the switching elements S1 and S2 are an upper arm element and the switching elements S3 and S4 are a lower arm element are formed for the first electrical source 31. The first chopper circuit may function as a boost chopper circuit for the first electrical source 31, when the vehicle 1 is in the power running state. In this case, the electrical power which is outputted from the first electrical source 31 is stored in the reactor L1 during a period in which the switching elements S3 and S4 are in the ON state. The electrical power which is stored in the reactor L1 is supplied to the electrical source line PL via at least one portion of the switching elements S1 and S2 and the diodes D1 and D2 during a period in which at least one of the switching elements S3 and S4 is in the OFF state. On the other hand, the first chopper circuit may function as a step-down chopper circuit for the first electrical source 31, when the vehicle 1 is in the regeneration state. In this case, the electrical power which is generated by the regeneration is stored in the reactor L1 during a period in which the switching elements S1 and S2 are in the ON state. The electrical power which is stored in the reactor L1 is supplied to the ground line GL via at least one portion of the switching elements S3 and S4 and the diodes D3 and D4 during a period in which at least one of the switching elements S1 and S2 is in the OFF state.

On the other hand, a second chopper circuit in which the switching elements S4 and S1 are an upper arm element and the switching elements S2 and S3 are a lower arm element are formed for the second electrical source 32. The second chopper circuit may function as a boost chopper circuit for the second electrical source 32, when the vehicle 1 is in the power running state. In this case, the electrical power which is outputted from the second electrical source 32 is stored in the reactor L2 during a period in which the switching elements S2 and S3 are in the ON state. The electrical power which is stored in the reactor L2 is supplied to the electrical source line PL via at least one portion of the switching elements S1 and S4 and the diodes D1 and D4 during a period in which at least one of the switching elements S2 and S3 is in the OFF state. On the other hand, the second chopper circuit may function as a step-down chopper circuit for the second electrical source 32, when the vehicle 1 is in the regeneration state. In this case, the electrical power which is generated by the regeneration is stored in the reactor L2 during a period in which the switching elements S1 and S4 are in the ON state. The electrical power which is stored in the reactor L2 is supplied to a line to which the negative terminal of the second electrical source 32 is connected via at least one portion of the switching elements S2 and S3 and the diodes D2 and D3 during a period in which at least one of the switching elements S1 and S4 is in the OFF state.

The electrical power converter 33 may perform the electrical power conversion such that the electrical power is transmitted between the first electrical source 31 and the second electrical source 32 which are electrically connected in parallel and the inverter 35 (alternatively, the motor generator 10). Alternatively, the electrical power converter 33 may perform the electrical power conversion such that the electrical power is transmitted between the first electrical source 31 and the second electrical source 32 which are electrically connected in series and the inverter 35 (alternatively, the motor generator 10).

Incidentally, the fluctuation of the voltage between the electrical source line PL and the ground line GL, which is caused by the change of the switching states of the switching elements S1 to D4, is suppressed by the smoothing capacitor C.

(3) External Appearance of Electrical Power Converter

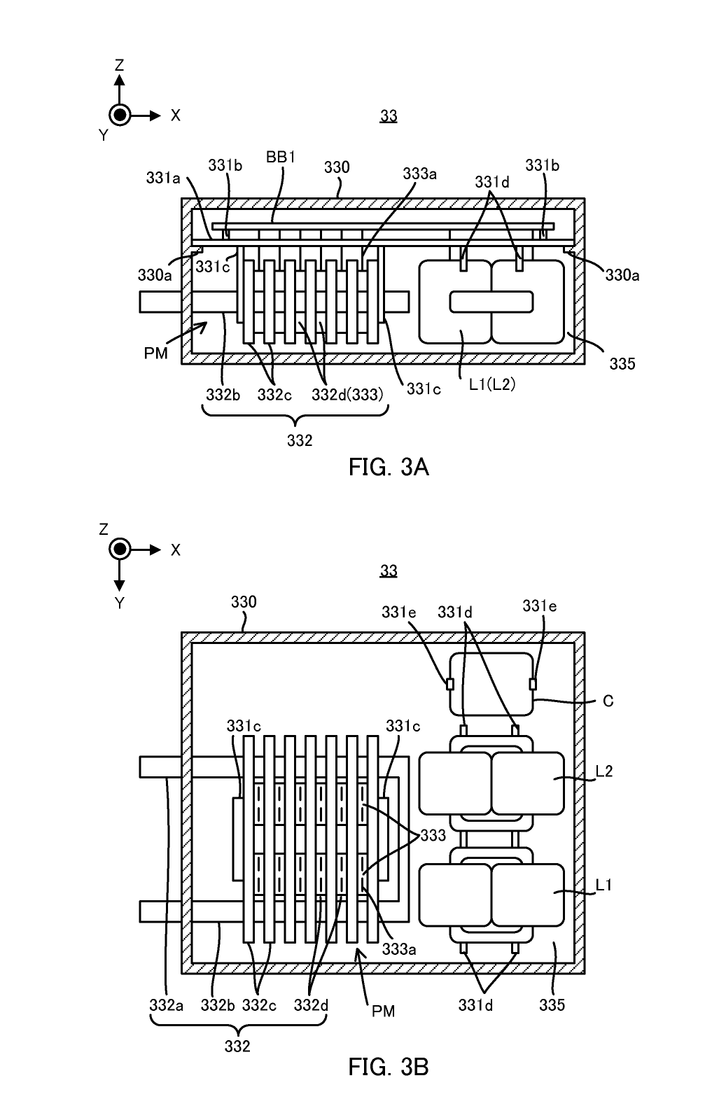

Next, with reference to FIG. 3A and FIG. 3B, the external appearance of the electrical power converter 33 will be explained. FIG. 3A is a side view illustrating the external appearance of the electrical power converter 33. FIG. 3B is a top view illustrating the external appearance of the electrical power converter 33. Incidentally, in FIG. 3A, only a chassis 330 is illustrated by using the cross-sectional view and elements other than the chassis 330 are illustrated by using the side view, for the purpose of improving the visibility of the drawing. Moreover, in FIG. 3B, an upper cover of the chassis 330, a conductive module BB1 and a bracket 331a, which are explained later, are omitted, for the purpose of improving the visibility of the drawing. Moreover, in FIG. 3A and FIG. 3B, the external appearance of the electrical power converter 33 is illustrated in a three dimensional coordinate space which is defined by an X axis, a Y axis and a Z axis.

As illustrated in FIG. 3A and FIG. 3B, the electrical power converter 33 has the box-shaped chassis 330. A plurality of plate-like semiconductor modules 333, the above described smoothing capacitor C and the above described reactors L1 and L2 are housed inside the chassis 330. Incidentally, another circuit element (for example, another capacitor and the like) may be further housed inside the chassis 330.

At least one of the above described switching elements S1 to S4 and the above described diodes D1 to D4 is housed in each of the plurality of semiconductor modules 333. Incidentally, in the present embodiment, an example in which twelve semiconductor modules 333 are housed in the electrical power converter 33 will be explained as illustrated in FIG. 3B. However, the semiconductor modules 333 whose number is less than or more than twelve may be housed in the electrical power converter 33.

The plurality of semiconductor modules 333 and a cooling module 332, which is one example of the “cooler”, are unified. However, the plurality of semiconductor modules 333 and the cooling module 332 may not be unified. In the following explanation, a module (a structure) which is obtained by unifying the plurality of semiconductor modules 333 and the cooling module 332 is referred to as a “power module PM”.

The cooling module 332 has an intake pipe 332a, an ejection pipe 332b and a plurality of cooling plates 332c. A coolant (for example, a cooling water), which is for cooling at least one of the plurality of semiconductor modules 333, the smoothing capacitor C and the reactors L1 and L2, is supplied to the intake pipe 332a. As a result, the coolant is supplied to the inside of the electrical power converter 33 via the intake pipe 332a. The coolant, which is supplied to the inside of the electrical power converter 33 via the intake pipe 332a, is ejected via the ejection pipe 332b. Each of the intake pipe 332a and the ejection pipe 332b penetrates the plurality of cooling plates 332c to support the plurality of cooling plates 332c such that the plurality of cooling plates 332c are arranged in parallel. An inside void of each of the intake pipe 332a and the ejection pipe 332b is coupled with an inside void of each of the plurality of cooling plates 332c. Therefore, the coolant which is supplied via the intake pipe 332a passes through the inside void of each of the plurality of cooling plates 332c and then is ejected via the ejection pipe 332b.

The semiconductor module 333 are inserted in a slit 332d between two adjacent cooling plates 332c. Namely, in the power module PM, the plurality of plate-like semiconductor modules 333 and the plurality of cooling plates 332c are alternately layered. As a result, each of the plurality of semiconductor modules 333 is cooled from both side thereof (from both surfaces along the X axis direction in FIG. 3A and FIG. 3B). Thus, each of the plurality of semiconductor modules 333 is cooled effectively.

Incidentally, FIG. 3B illustrates an example in which two semiconductor modules 333 are inserted in each slit 332d. However, one semiconductor module 333 or three or more semiconductor modules 333 may be inserted in each slit 332d.

The reactors L1 and L2 are located beside the power module PM (on a lateral side of the power module PM toward the positive X axis direction in FIG. 3A and FIG. 3B). Incidentally, in an example illustrated in FIG. 3B, two reactors (namely, the reactors L1 and L2) are housed in one chassis 330. However, one reactor (namely, either one of the reactors L1 and L2) or three or more reactors may be housed in one chassis 330.

The smoothing capacitor C is located beside the power module PM. The smoothing capacitor C is located on a lateral side of the power module PM (on a lateral side of the power module PM toward the negative Y axis direction in FIG. 3B), which is different from the lateral side of the power module PM on which the reactors L1 and L2 are located.

The power module PM is fixed to the bracket 331a, which is located above the power module PM, by stays 331c each of which extends toward an upper side (toward a positive Z axis direction in FIG. 3A). The reactors L1 and L2 are fixed to the bracket 331a, which is located above the reactors L1 and L2, by stays 331d each of which extends toward the upper side (toward the positive Z axis direction in FIG. 3A). The smoothing capacitor C is fixed to the bracket 331a which is located above the smoothing capacitor C by stays 331e each of which extends toward the upper side (toward the positive Z axis direction in FIG. 3A). The bracket 331a is located inside the chassis 330 such that a fringe of the bracket 331a is fixed to an inner flange 330a of the chassis 330.

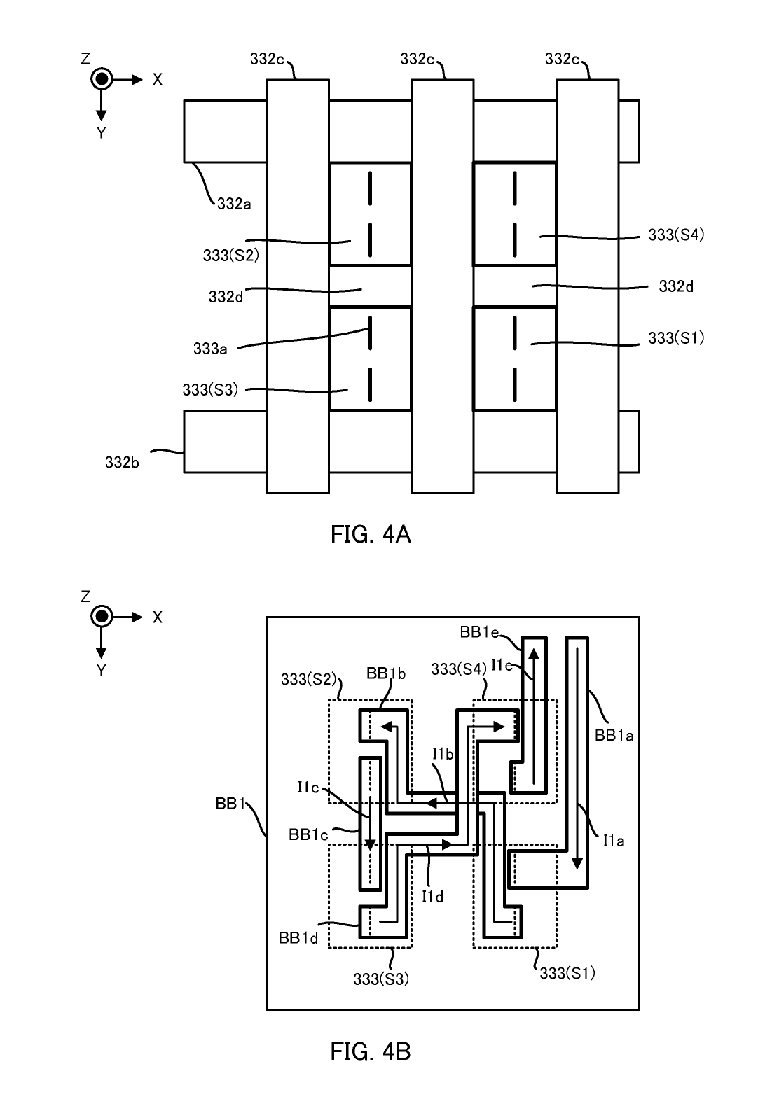

The conductive module BB1 is fixed to the bracket 331a by stays 331b each of which extends toward the upper side (toward the positive Z axis direction in FIG. 3A). The conductive module BB1 is a module for electrically connecting the plurality of semiconductor modules 333, the reactors L1 and L2 and the smoothing capacitor C. A lead wire 333a extends from each of the plurality of semiconductor modules 333 to the conductive module BB1. A lead wire also extends from each of the reactors L1 and L2 to the conductive module BB1. A lead wire also extends from the smoothing capacitor C to the conductive module BB1 (however, this lead wire is not illustrated in FIG. 3A and FIG. 3B). The conductive module BB1 has conductive paths (in other words, electrical paths, refer to the below described FIG. 4 and so on) which electrically connect these lead wires. As a result, the plurality of semiconductor modules 333, the reactors L1 and L2 and the smoothing capacitor C are electrically connected.

Incidentally, the conductive module BB1 may be a module in which the plurality of conductive paths are sealed by an insulating resin. Alternatively, the conductive module BB1 may be a module in which a plurality of bus bars, each of which is made by a sheet-metal processing of a metal plate, are combined as the plurality of conductive paths. Anyway, the structure of the conductive module BB1 may be any as long as the conductive module BB1 is capable of electrically connecting the plurality of semiconductor modules 333, the reactors L1 and L2 and the smoothing capacitor C

(4) First Example of Arrangement of Semiconductor Modules 333

Next, with reference to FIG. 4A and FIG. 4B, a first example of an arrangement aspect of four semiconductor modules 333, in which the series-connected switching elements S1 to S4 are housed respectively, will be explained. FIG. 4A is a top view illustrating the first example of the arrangement aspect of the four semiconductor modules 333, in which the series-connected switching elements S1 to S4 are housed respectively. FIG. 4B is a planar view illustrating the conductive paths of the conductive module BB1 which is used in the case where the four semiconductor modules 333, in which the series-connected switching elements S1 to S4 are housed respectively, are arranged in the arrangement aspect of the first example illustrated in FIG. 4A. Incidentally, in FIG. 4A and FIG. 4B, the arrangement aspect of the semiconductor modules 333 is illustrated in the three dimensional coordinate space which is same as the three dimensional coordinate space used in FIG. 3A and FIG. 3B.

As illustrated in FIG. 4A, the four semiconductor modules 333, in which the series-connected switching elements S1 to S4 are housed respectively, are located at four corners (four vertexes) of a planar quadrangular region (a planar quadrangular region which is parallel to an XY plane, in an example illustrated in FIG. 4A), respectively. In other words, the four semiconductor modules 333, in which the switching elements S1 to S4 are housed respectively, are located such that a virtual line which connects the four semiconductor modules 333 forms the planer quadrangular region. In other words, the four semiconductor modules 333, in which the switching elements S1 to S4 are housed respectively, are located to be arranged in a square arrangement manner (alternatively, a matrix arrangement manner).

Incidentally, in the following explanation, the semiconductor module 333 in which the switching element Sk (k is 1, 2, 3 or 4) is housed is referred to as the “semiconductor module 333(Sk)”, for the purpose of illustration. Moreover, it is assumed that the term “four semiconductor modules 333” means the four semiconductor modules 333, in which the series-connected switching elements S1 to S4 are housed respectively, if there is no annotation.

As illustrated in FIG. 4A, it is preferable that the four semiconductor modules 333 be located at the four corners of a planar square or oblong (in other words, rectangular) region, respectively. However, the four semiconductor modules 333 may be located at the four corners of a planar diamond or parallelogram region, respectively. Alternatively, the four semiconductor modules 333 may be located at the four corners of a planar quadrangular region whose shape is different from the above described shape, respectively. In the following explanation, an example in which the four semiconductor modules 333 are located at the four corners of the planar rectangular region will be explained.

Specifically, two semiconductor modules 333 among the four semiconductor modules 333 are inserted in each of two adjacent slits 332d. For example, two semiconductor modules 333 (the semiconductor modules 333(S2) and 333(S3) in the example illustrated in FIG. 4A) among the four semiconductor modules 333 are inserted in the left slit 332d in FIG. 4A such that these two semiconductor modules 333 line along an extending direction of the left slit 332d (along the Y axis direction). Furthermore, the other two semiconductor modules 333 (the semiconductor modules 333(S1) and 333(S4) in the example illustrated in FIG. 4A) among the four semiconductor modules 333 are inserted in the right slit 332d in FIG. 4A such that these two semiconductor modules 333 line along an extending direction of the right slit 332d.

In addition, in the present embodiment, at least two of the plurality of conductive paths, which electrically connect the four semiconductor modules 333, physically intersect with each other. In other words, the four semiconductor modules 333 are located such that at least two of the plurality of conductive paths, which electrically connect the four semiconductor modules 333, physically intersect with each other.

It is preferable that the conductive path which electrically connects two semiconductor modules 333 among the four semiconductor modules 333 physically intersect with the conductive path which electrically connects the other two semiconductor modules 333 among the four semiconductor modules 333. In other words, it is preferable that the four semiconductor modules 333 be located such that the conductive path which electrically connects two semiconductor modules 333 among the four semiconductor modules 333 physically intersects with the conductive path which electrically connects the other two semiconductor modules 333 among the four semiconductor modules 333. For example, it is preferable that the four semiconductor modules 333 be located such that the conductive path which electrically connects two semiconductor modules 333 on a first diagonal line of the virtual planar quadrangular region formed by the four semiconductor modules 333 physically intersects with the conductive path which electrically connects the other two semiconductor modules 333 on a second diagonal line of the virtual planar quadrangular region formed by the four semiconductor modules 333.

In the present embodiment, as illustrated in FIG. 4B, a conductive path BB1b which is one example of the “first conductive path” and a conductive path BB1d which is one example of the “second conductive path” physically intersect with each other. In other words, the four semiconductor modules 333 are located such that the conductive paths BB1b and BB1d physically intersect with each other. Incidentally, the conductive path BB1b is a conductive path which electrically connects the semiconductor module 333(S1) which is inserted in the right slit 332d and the semiconductor module 333(S2) which is inserted in the left slit 332d. The conductive path BB1d is a conductive path which electrically connects the semiconductor module 333(S3) which is inserted in the left slit 332d and the semiconductor module 333(S4) which is inserted in the right slit 332d. In this case, the conductive paths BB1b and BB1d are electrically insulated at a position where the conductive paths BB1b and BB1d intersect with each other.

Incidentally, if the conductive module BB1 is the module in which the plurality of conductive paths are sealed by the insulating resin, each of the conductive paths BB1b and BB1d corresponds to the conductive path sealed by the insulating resin. If the conductive module BB1 is the module in which the plurality of bus bars, each of which is made by the sheet-metal processing of the metal plate, are combined, each of the conductive paths BB1b and BB1d corresponds to the bus bar. Same argument can be applied to below described conductive paths BB1a, BB1c and BB1e.

The conductive path BB1b has a shape having a conductive path part extending along the X axis direction and a conductive path part extending along the Y axis direction on the plane (for example, XY plane) to reach from the semiconductor module 333(S1) to the semiconductor module 333(S2). However, the conductive path BB1b may has any shape as long as the conductive path BB1b is capable of electrically connecting the semiconductor module 333(S1) and the semiconductor module 333(S2). Similarly, in FIG. 4B, the conductive path BB1d has a shape having a conductive path part extending along the X axis direction and a conductive path part extending along the Y axis direction on the plane (for example, the XY plane) to reach from the semiconductor module 333(S3) to the semiconductor module 333(S4). However, the conductive path BB1d may has any shape as long as the conductive path BB1d is capable of electrically connecting the semiconductor module 333(S3) and the semiconductor module 333(S4). Anyway, each of the conductive paths BB1b and BB1d may have any shape as long as one portion of the conductive path BB1b and one portion of the conductive path BB1d intersect with each other.

In addition, in the present embodiment, one portion of each of the other conductive paths other than the physically-intersected conductive paths extends along the same direction. In other words, the four semiconductor modules 333 are located such that one portion of each of the other conductive paths other than the physically-intersected conductive paths extends along the same direction. However, the other conductive paths other than the physically intersected conductive paths may extend along different directions, respectively.

Furthermore in the present embodiment, as illustrated in FIG. 4B, one portion of the conductive path BB1a which is one example of the “third conductive path”, the conductive path BB1c which is one example of the “fifth conductive path” and one portion of the conductive path BB1e which is one example of the “fourth conductive path” extend along the same direction (along the Y axis direction in FIG. 4B). In other words, the four semiconductor modules 333 are located such that one portion of the conductive path BB1a, the conductive path BB1c and one portion of the conductive path BB1e extend along the same direction. In this case, it is preferable that the conductive paths BB1a and BB1e extend such that one portion of the conductive path BB1a and one portion of the conductive path BB1e are adjacent to or close to each other. Incidentally, the conductive path BB1a is a conductive path which electrically connects the smoothing capacitor C and the semiconductor module 333(S1) which is inserted in the right slit 332d. The conductive path BB1c is a conductive path which electrically connects the semiconductor module 333(S2) which is inserted in the left slit 332d and the semiconductor module 333(S3) which is inserted in the left slit 332d. The conductive path BB1a is a conductive path which electrically connects the smoothing capacitor C and the semiconductor module 333(S4) which is inserted in the right slit 332d.

However, the conductive paths BB1a and BB1c may extend along the different directions, respectively. The conductive paths BB1e and BB1c may extend along the different directions, respectively. The conductive paths BB1a and BB1e may extend along the different directions, respectively.

Incidentally, one portion of the conductive path BB1a, the conductive path BB1c and one portion of the conductive path BB1e extend along the direction along which one portion of the conductive path BB1b and one portion of the conductive path BB1d extend, because one portion of the conductive path BB1b and one portion of the conductive path BB1d extend along the Y axis direction. However, at least one of the conductive paths BB1a, BB1c and BB1e may not extend along the direction along which the conductive paths BB1b and BB1d extend.

Moreover, in the above described explanation, each of the conductive paths BB1a to BB1e extends along the X axis direction or the Y axis direction. However, at least one of the conductive paths BB1a to BB1e may extend along a direction which is different from the X axis direction and the Y axis direction. Namely, the extending direction of each of the conductive paths BB1a to BB1e is not limited to the X axis direction and the Y axis direction.

Furthermore in the present embodiment, one semiconductor module 333 whose heat generation amount is largest among the four semiconductor modules 333 is located at more upstream part along a supplying direction of the coolant than the other semiconductor modules 333 other than the one semiconductor module 333 among the four semiconductor modules 333 are. Namely, one semiconductor module 333 whose heat generation amount is largest among the four semiconductor modules 333 is located at a position which is nearest to the upstream part of the intake pipe 332a. FIG. 4A and FIG. 4B illustrates an example in which the semiconductor module 333(S2) is one semiconductor module 333 whose heat generation amount is largest. This is because a switching loss of the switching element S2 is larger than that of each of the other switching elements when the electrical power converter 33 of the present embodiment operates. Incidentally, one semiconductor module 333 whose heat generation amount is largest is determined depending on a control aspect of the switching elements S1 to S4 which are housed in the four semiconductor modules 333 respectively.

However, one semiconductor module 333 whose heat generation amount is largest among the four semiconductor modules 333 may not located at more upstream part along a supplying direction of the coolant than the other semiconductor modules 333 other than the one semiconductor module 333 among the four semiconductor modules 333.

As described above, in the first example, the four semiconductor modules 333, in which the series-connected switching elements S1 to S4 are housed respectively, are located such that at least two of the plurality of conductive paths which electrically connect the four semiconductor modules 333 physically intersect with each other. More specifically, the four semiconductor modules 333 are located such that the conductive paths BB1b and BB1d physically intersect with each other. Thus, as illustrated in FIG. 4B, an electrical current I1d flows in the conductive path BB1d (especially, the conductive path part of the conductive path BB1d extending along the X axis direction) toward the positive X axis direction, when an electrical current I1b flows in the conductive path BB1b (especially, the conductive path part of the conductive path BB1b extending along the X axis direction) toward the negative X axis direction. On the other hand, the electrical current I1d flows in the conductive path BB1d (especially, the conductive path part of the conductive path BB1d extending along the X axis direction) toward the negative X axis direction, when the electrical current I1b flows in the conductive path BB1b (especially, the conductive path part of the conductive path BB1b extending along the X axis direction) toward the positive X axis direction. Namely, a flowing direction of the electrical current I1b which flows in at least one portion of the conductive path BB1b (namely, the conductive path part of the conductive path BB1b extending along the X axis direction) is opposite to a flowing direction of the electrical current I1d which flows in at least one portion of the conductive path BB1d (namely, the conductive path part of the conductive path BB1d extending along the X axis direction). When the electrical currents I1b and I1d, whose flowing directions are opposite to each other, flow through the conductive paths BB1b and BB1d, respectively, an inductance (for example, a parasitic inductance) of the conductive path BB1b and an inductance (for example, a parasitic inductance) of the conductive path BB1d cancel (in other words, compensate) each other. Therefore, the inductance of the electrical power converter 33 is appropriately reduced (decreased) even in the electrical power converter 33 in which the switching elements S1 and S4 are electrically connected in series.

In addition, the four semiconductor modules 333, in which the series-connected switching elements S1 to S4 are housed respectively, are located such that one portion of each of the other conductive paths other than the physically-intersected conductive paths extends along the same direction. Specifically, the four semiconductor modules 333 are located such that one portion of the conductive path BB1a, the conductive path BB1c and one portion of the conductive path BB1e extend along the same direction. Thus, as illustrated in FIG. 4B, an electrical current I1e flows in the conductive path BB1c toward the positive Y axis direction and an electrical current I1e flows in the conductive path BB1e toward the negative Y axis direction, when an electrical current I1a flows in the conductive path BB1a toward the positive Y axis direction. On the other hand, the electrical current I1c flows in the conductive path BB1c toward the negative Y axis direction and the electrical current I1e flows in the conductive path BB1e toward the positive Y axis direction, when the electrical current I1a flows in the conductive path BB1a toward the negative Y axis direction. Namely, a flowing direction of the electrical current I1a which flows in the conductive path BB1a and a flowing direction of the electrical current I1e which flows in the conductive path BB1c are opposite to a flowing direction of the electrical current I1e which flows in the conductive path BB1e. When the electrical currents I1a/I1e and I1e, whose flowing directions are opposite to each other, flow through the conductive paths BB1a/BB1c and BB1e, respectively, an inductance (for example, a parasitic inductance) of the conductive paths BB1a and BB1c and an inductance (for example, a parasitic inductance) of the conductive path BB1e cancel (in other words, compensate) each other. Especially, the inductance of the conductive path BB1a and the inductance of the conductive path BB1e cancel each other easily, because one portion of each of the conductive paths BB1a and BB1e extend along the Y axis direction to be adjacent to each other. Therefore, the inductance of the electrical power converter 33 is appropriately reduced (decreased) even in the electrical power converter 33 in which the switching elements S1 and S4 are electrically connected in series.

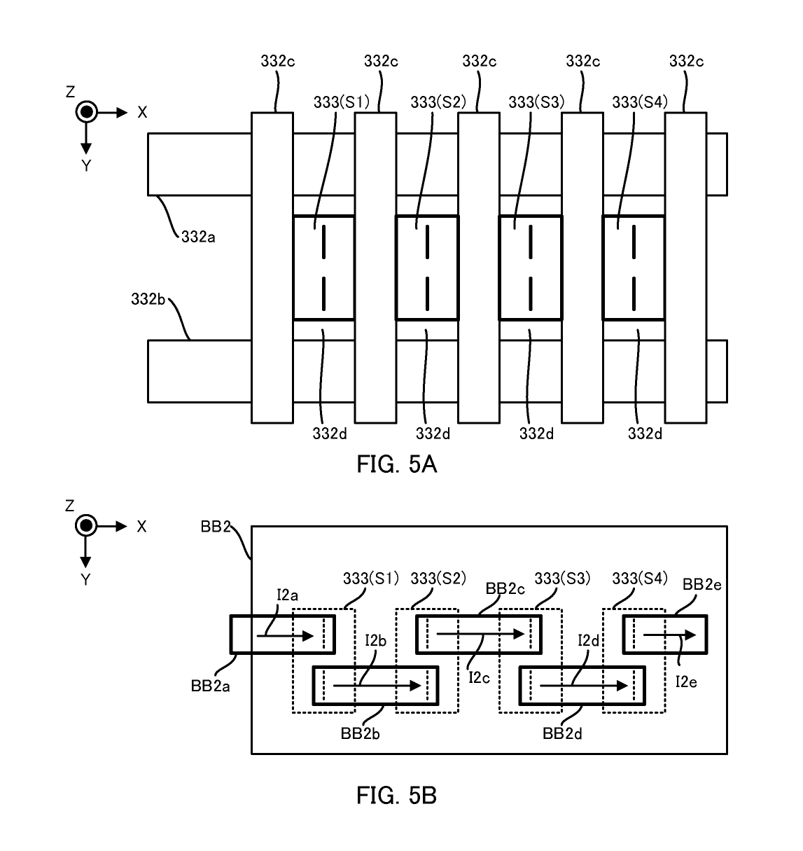

Here, with reference to FIG. 5A and FIG. 5B, the reduction of the inductance which is realized by the first example will be explained while comparing the electrical power converter 33 of the first example with an electrical power converter of a comparative example in which the four semiconductor modules 333 are located to line along a straight line (in other words, physically in tandem) on the plane. FIG. 5A is a top view illustrating the comparative example of an arrangement aspect in which the four semiconductor modules 333, in which the series-connected four switching elements S1 to S4 are housed respectively, are arranged to line along the straight line (in other words, physically in tandem). FIG. 5B is a planar view illustrating the conductive paths of a conductive module BB2 which is used in the case where the four semiconductor modules 333, in which the series-connected switching elements S1 to S4 are housed respectively, are arranged in the arrangement aspect illustrated in FIG. 5A.

As illustrated in FIG. 5A, in the comparative example, the four semiconductor modules 333 are located to line along the straight line on the plane (for example, the XY plane). Namely, the four semiconductor modules 333 are located such that the four semiconductor modules 333 are inserted in the four slit 332d, respectively, wherein the four slit 332d line along the straight line on the plane (for example, the XY plane). More specifically, the four semiconductor modules 333 are located such that the semiconductor modules 333(S1), 333(S2), 333(S3) and 333(S4) line in this order (namely, in an order of the electrical series connection).

In this case, as illustrated in FIG. 5B, a flowing direction of an electrical current I1a which flows in the conductive path BB2a, a flowing direction of an electrical current I2b which flows in the conductive path BB2b, a flowing direction of an electrical current I2c which flows in the conductive path BB2c, a flowing direction of an electrical current I2d which flows in the conductive path BB2d and a flowing direction of an electrical current I2e which flows in the conductive path BB2e are same. Incidentally, the conductive path BB2a is a conductive path which electrically connects the smoothing capacitor C and the semiconductor module 333(S1). The conductive path BB2b is a conductive path which electrically connects the semiconductor module 333(S1) and the semiconductor module 333(S2). The conductive path BB2c is a conductive path which electrically connects the semiconductor module 333(S2) and the semiconductor module 333(S3). The conductive path BB2d is a conductive path which electrically connects the semiconductor module 333(S3) and the semiconductor module 333(S4). The conductive path BB2e is a conductive path which electrically connects the semiconductor module 333(S4) and the smoothing capacitor C. Thus, an inductance of the conductive path BB2a, an inductance of the conductive path BB2b, an inductance of the conductive path BB2c, an inductance of the conductive path BB2d and an inductance of the conductive path BB2e do not cancel each other. Therefore, the inductance of the electrical power converter 33 is less likely reduced (decreased) by the arrangement aspect of the comparative example.

On the other hand, in the first example, as described above, the four semiconductor modules 333 are located such that the conductive paths BB1b and BB1d physically intersect with each other and the inductance of the conductive path BB1b and the inductance of the conductive path BB1d cancel each other. Moreover, in the first example, the four semiconductor modules 333 are located such that one portion of the conductive path BB1a, one portion of the conductive path BB1c and one portion of the conductive path BB1e extend along the same direction and the inductance of the conductive paths BB1a and BB1c and the inductance of the conductive path BB1e cancel each other. Therefore, the inductance of the electrical power converter 33 is appropriately reduced (decreased) in the first example, compared to the electrical power converter of the comparative example.

In addition, in the first example, the four semiconductor modules 333 are located on the four corners of the planar quadrangular region, respectively, instead of being located to line along the straight line on the plane. Therefore, in the first example, the electrical power converter 33 decreases in size compared to the electrical power converter of the comparative example. The reason is as follows. In the electrical power converter 33 of the comparative example, a region where the four semiconductor modules 333 (alternatively, the power module PM) are located is more likely to excessively extend along one direction (specifically, a direction along which the four semiconductor modules 333 line), because the four semiconductor modules 333 line along the straight line. Therefore, if the smoothing capacitor C and the reactors L1 and L2 are located beside the power module PM, the size of the electrical power converter 33 is relatively large (for example, only the size along the one direction is excessively large). However, in the first example, the region where the four semiconductor modules 333 are located is less likely to excessively extend along the one direction. As a result, in the first example, the size of the electrical power converter 33 is less likely relatively large (for example, only the size along the one direction is less likely excessively large). Thus, the electrical power converter 33 decreases in entire size compared to the electrical power converter of the comparative example.

In addition, in the first example, one semiconductor module 333 whose heat generation amount is largest among the four semiconductor modules 333 is located at a position which is nearest to the upstream part of the intake pipe 332a. Therefore, the cooling module 332 is capable of cooling the four semiconductor modules 333 effectively.

(5) Second Example of Arrangement of Semiconductor Modules 333

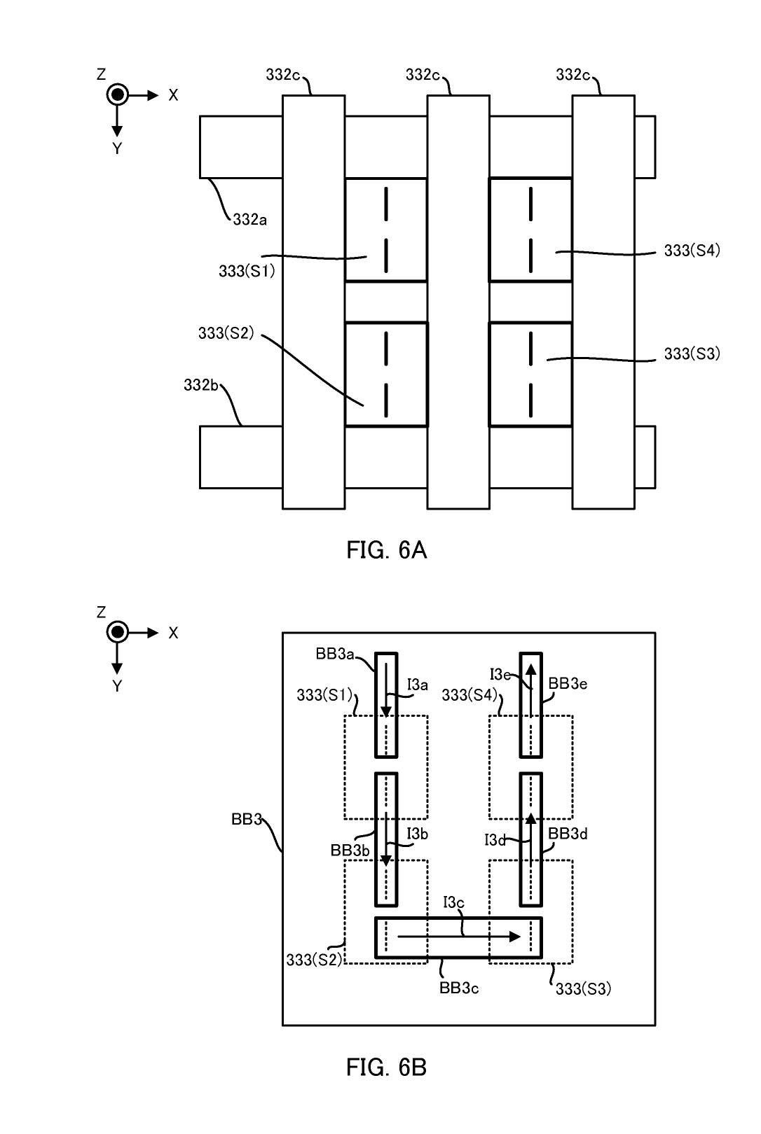

Next, with reference to FIG. 6A and FIG. 6B, a second example of an arrangement aspect of four semiconductor modules 333, in which the series-connected switching elements S1 to S4 are housed respectively, will be explained. FIG. 6A is a top view illustrating the second example of the arrangement aspect of the four semiconductor modules 333, in which the series-connected switching elements S1 to S4 are housed respectively. FIG. 6B is a planar view illustrating the conductive paths of the conductive module BB3 which is used in the case where the four semiconductor modules 333, in which the series-connected switching elements S1 to S4 are housed respectively, are arranged in the arrangement aspect illustrated in FIG. 6A. Incidentally, in FIG. 6A and FIG. 6B, the arrangement aspect of the semiconductor modules 333 is illustrated in the three dimensional coordinate space which is same as the three dimensional coordinate space used in FIG. 3A and FIG. 3B. Moreover, in the following explanation, a feature which is different from the feature of the first example will be explained mainly and a feature which is same as the feature of the first example is omitted.

As illustrated in FIG. 6A, also in the second example, the four semiconductor modules 333 are located on the four corners (for vertexes) of the planar quadrangular region, respectively, as with the first example.

The arrangement aspect of the second example is different from the arrangement aspect of the first example in that at least two of the plurality of conductive paths, which electrically connect the four semiconductor modules 333, are not need to physically intersect with each other. In this case, in the second example, as illustrated in FIG. 6B, the plurality of conductive paths, which electrically connect the four semiconductor modules 333, form an electrical current path in a loop shape or a circular shape (an open loop shape in the example illustrated in FIG. 6B) on the plane (for example, the XY plane). In other words, the four semiconductor modules 333 are located such that the plurality of conductive paths, which electrically connect the four semiconductor modules 333, form the electrical current path in the loop shape or the circular shape on the plane.

Specifically, in the example illustrated in FIG. 6B, a conductive path BB3a, a conductive path BB3b, a conductive path BB3c, a conductive path BB3d and a conductive path BB3e are located in the loop shape to be arranged in this order. In this case, two semiconductor modules 333 (the semiconductor modules 333(S1) and 333(S2) in the example illustrated in FIG. 6A) among the four semiconductor modules 333 are inserted in the left slit 332d in FIG. 6A such that these two semiconductor modules 333 line along the extending direction of the left slit 332d (along the Y axis direction). Furthermore, the other two semiconductor modules 333 (the semiconductor modules 333(S3) and 333(S4) in the example illustrated in FIG. 6A) among the four semiconductor modules 333 are inserted in the right slit 332d in FIG. 6A such that these two semiconductor modules 333 line along the extending direction of the right slit 332d.

Incidentally, the conductive path BB3a is a conductive path which electrically connects the smoothing capacitor C and the semiconductor module 333(S1). Therefore, the conductive path BB3a is one example of the “third conductive path”. The conductive path BB3b is a conductive path which electrically connects the semiconductor module 333(S1) and the semiconductor module 333(S2). Therefore, the conductive path BB3b is one example of the “first conductive path”. The conductive path BB3c is a conductive path which electrically connects the semiconductor module 333(S2) and the semiconductor module 333(S3). Therefore, the conductive path BB3c is one example of the “fifth conductive path”. The conductive path BB3d is a conductive path which electrically connects the semiconductor module 333(S3) and the semiconductor module 333(S4). Therefore, the conductive path BB3d is one example of the “second conductive path”. The conductive path BB3e is a conductive path which electrically connects the semiconductor module 333(S4) and the smoothing capacitor C. Therefore, the conductive path BB3e is one example of the “fourth conductive path”.

As described above, in the second example, the conductive paths BB3a, BB3b, BB3c, BB3d and BB3e are located in the loop shape to be arranged in this order. Therefore, in the second example, a length (for example, a physical length) of the electrical current path is shorter than the electrical current path in the first example. Thus, the inductance of the electrical power converter 33 is reduced (decreased) to some extent even also in the second example, because the inductance of the electrical current path is proportional to the length of the electrical current path.

Incidentally, at least one portion of various features which are explained in the first example may be applied in the second example.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention. An electrical power converter, which involve such changes, are also intended to be within the technical scope of the present invention.

### CROSS-REFERENCE TO RELATED APPLICATIONS

This application is based upon and claims the benefit of priority of the prior Japanese Patent Application No. 2014-024350, file on Feb. 12, 2014, the entire contents of which are incorporated herein by reference. In addition, the entire contents of the above described Patent Literatures 1 to 3 are incorporated herein by reference.

### DESCRIPTION OF REFERENCE CODES

1 vehicle
30 electrical source system
31 first electrical source
32 second electrical source
33 electrical power converter
332 cooling module
332a intake pipe
332b ejection pipe
332c cooling plate
332d slit
333 semiconductor module
333a lead wire
BB1, BB3 conductive module
BB1a, BB1b, BB1c, BB1d, BB1e conductive path
BB3a, BB3b, BB3c, BB3d, BB3e conductive path
C smoothing capacitor
L1, L2 reactor
PM power module
S1, S2, S3, S4 switching element

What is claimed is:

1. An electrical power converter which is configured to perform an electrical power conversion with two electricity storage apparatuses,
the electrical power converter comprising:
four switching elements which are electrically connected in series and which are housed in the electrical power converter such that the four switching elements are located at four corners of a planar quadrangular region respectively;
a first conductive path which electrically connects a first and second switching elements among the four switching elements; and
a second conductive path which electrically connects a third and fourth switching elements among the four switching elements, wherein
the second conductive path intersects with the first conductive path in a planar view.

2. The electrical power converter according to claim 1, wherein
at least one portion of the first conductive path extends along a direction along which at least one portion of the second conductive path extends.

3. The electrical power converter according to claim 1, wherein
a flowing direction of an electrical current which flows through at least one portion of the first conductive path is opposite to a flowing direction of an electrical current which flows through at least one portion of the second conductive path.

4. The electrical power converter according to claim 1 further comprising:
a smoothing capacitor which is electrically connected in parallel to the four switching elements;
a third conductive path which electrically connects the smoothing capacitor and the first switching element; and
a fourth conductive path which electrically connects the fourth switching element and the smoothing capacitor,
at least one portion of the fourth conductive path extends along a direction along which at least one portion of the third conductive path extends in a planar view.

5. The electrical power converter according to claim 4 further comprising a fifth conductive path which electrically connects the second and third switching elements,
at least one portion of the fifth conductive path extends along a direction along which at least one of at least one portion of the third conductive path and at least one portion of the fourth conductive path extends in a planar view.

6. The electrical power converter according to claim 1, wherein
the four switching elements are housed in the electrical power converter such that the first and second switching elements are located on a diagonal line of the planar quadrangular region and the third and fourth switching elements are located on a diagonal line of the planar quadrangular region.

7. The electrical power converter according to claim 1 further comprising a cooler to which a coolant for cooling the four switching elements is supplied, wherein
one switching element whose heat generation amount is largest among the four switching elements is located at more upstream part along a supplying direction of the coolant than the other switching elements other than the one switching element among the four switching elements.
